(19) United States
(12) Patent Application Publication
(10) Pub. No.: US 2007/0084015 A1
(43) Pub. Date: Apr. 19, 2007

(54) HINGE ASSEMBLY SYSTEM FOR PORTABLE ELECTRONIC DEVICES

(75) Inventors: Zhou-Quan Zuo, Shenzhen (CN); Chia-Hua Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO,. LTD., Shenzhen (CN); Sutech Trading Limited, Tortola (VG)

(21) Appl. No.: 11/309,596

(22) Filed: Aug. 29, 2006

(30) Foreign Application Priority Data
Oct. 14, 2005 (CN) 200510100372.2

(51) Int. Cl. E05D 7/00

(52) U.S. Cl. 16/354

(57) ABSTRACT

A hinge assembly system (200) includes a hinge assembly structure (210) and a driving structure (220). The driving structure includes a driving shaft (50), a gear (60) and a sliding unit (70). The gear engages with the driving shaft in a manner such that the gear may drive the driving shaft to rotate but the driving shaft cannot drive the gear to rotate. The sliding unit includes a rack (72). The rack drives the gear to rotate. The driving structure provides a force allowing the hinge assembly structure to cause the hinge assembly to rotate.

### DESCRIPTION

1. Field of the Invention

The present invention relates to hinge assemblies and, more particularly, to a hinge assembly system with a driving structure for an electronic device that can simplify the operation of the electronic device.

2. Description of Related Art

At present, perhaps the most popular portable electronic device in the marketplace is the foldable cellular telephone, which generally includes a cover and a main body. The cover and the main body are rotatably interconnected through a hinge assembly, for switching the telephone between an in-use position and a closed position.

One kind of hinge assembly employs a cam and a follower, enabling the cover section to open up from the body section and hold in an open position. An example of such kind of hinge assembly is disclosed in U.S. Pat. No. 6,292,980. The hinge assembly includes a cam having a concave portion, a shaft having a convex portion, and a spring which can bring the concave portion into tight contact with the convex portion. The cam, the shaft and the spring are received in a housing. A folder cover rotates about a main body of the mobile phone by overcoming the force of the spring, to make the concave portion rotate about the convex portion. However, a user must open the mobile phone using both hands. This makes the mobile phone awkward to utilize in situations when the user has only one hand free.

Therefore, a new hinge system is desired in order to overcome the above-described shortcoming.

### SUMMARY OF THE INVENTION

One embodiment of the present hinge assembly system includes a hinge assembly structure and a driving structure. The driving structure includes a driving shaft, a gear and a sliding unit. The gear engages with the driving shaft in a manner such that the gear may drive the driving shaft to rotate but the driving shaft cannot drive the gear to rotate. The sliding unit includes a rack. The rack drives the gear to rotate. The driving structure provides a force for the hinge assembly structure which can cause the hinge assembly to rotate.

Other objects, advantages and novel features of the present hinge assembly system will become more apparent from the following detailed description when taken in conjunction with the accompanying drawings.

### BRIEF DESCRIPTION OF THE DRAWINGS

Many aspects of the hinge assembly system can be better understood with reference to the following drawings. The components in the drawings are not necessarily drawn to scale, the emphasis instead being placed upon clearly illustrating the principles of the present hinge assembly system. Moreover, in the drawings, like reference numerals designate corresponding parts throughout the several views.

FIG. 1 is an isometric view of an embodiment of the present hinge assembly system, as used in a mobile phone;

FIG. 2 is an exploded, isometric view of the hinge assembly system shown in FIG. 1;

FIG. 3 is similar to FIG. 2, but viewed from another aspect;

FIG. 4 is an exploded, isometric view of the cover section and the housing section of the mobile phone shown in FIG. 1;

FIG. 5 is similar to FIG. 4, but viewed from another aspect;

FIG. 6 is an assembled view of the hinge assembly system shown in FIGS. 2 and 3;

FIG. 7 is a partially assembled view of the hinge assembly system with the mobile phone;

FIG. 8 is an assembled view of the hinge assembly system in a position corresponding to a close state of the mobile phone; and

FIG. 9 is an isometric view showing the hinge assembly system in a position corresponding to an open state of the mobile phone.

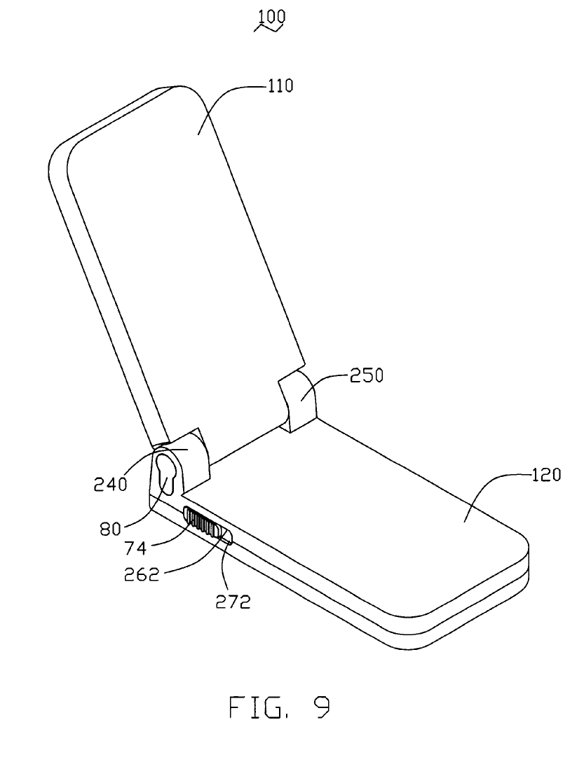

### DETAILED DESCRIPTION OF THE EMBODIMENTS

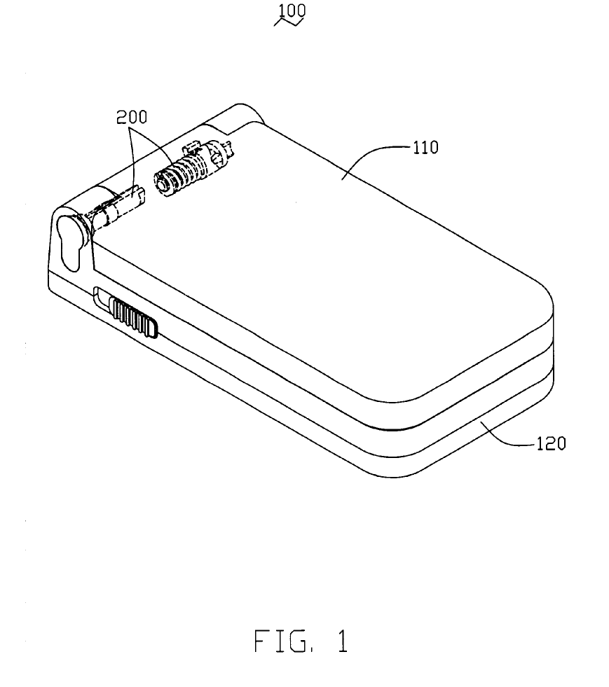

Referring now to the drawings in detail, FIG. 1 shows that a hinge assembly system 200, applied to a portable electronic device 100 such as a folder type mobile phone, for pivotally coupling a cover section 110 and a body section 120 together. It is to be understood, however, that the hinge assembly system 200 could be advantageously used in other environments. As such, although proving particularly advantageous when used in foldable electronic devices, the hinge assembly system 200 should not be considered limited in scope solely to an intended use environment of foldable electronic devices.

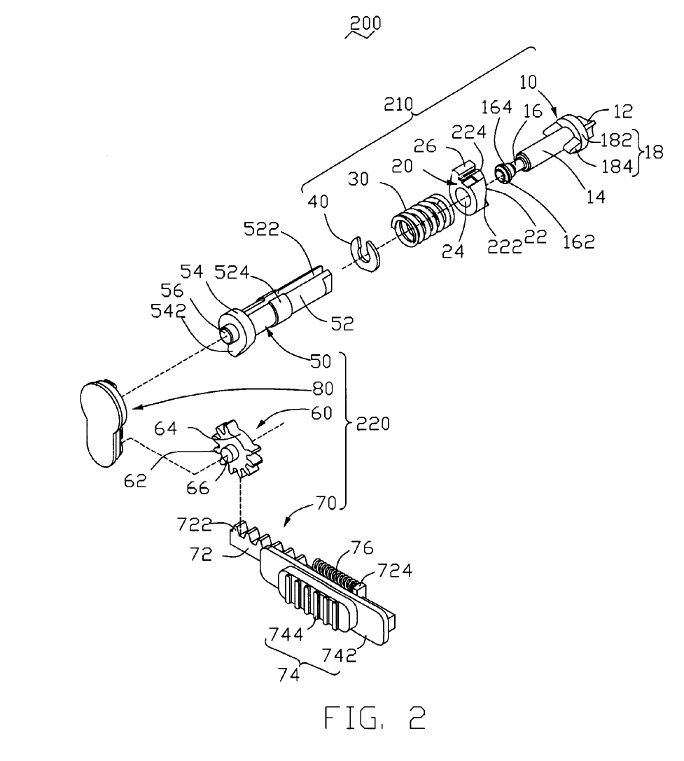

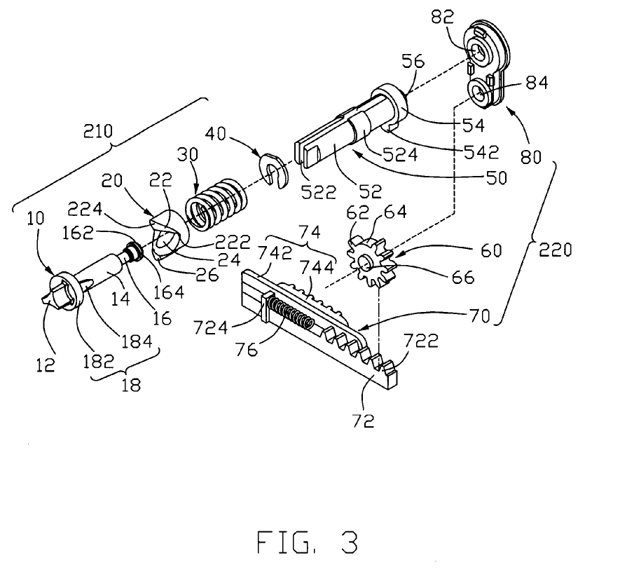

Referring to FIGS. 2 and 3, the hinge assembly system 200 includes a hinge structure 210 and a driving structure 220. The hinge structure 210 includes a shaft 10, a cam 20, a first spring 30, and a locking member 40. The shaft 10 passes through the cam 20, the first spring 30 and the locking member 40 in that order, thereby integrating the hinge structure 210 into a modular unit.

The shaft 10 includes a fixed portion 12, a main shaft portion 14 and a secondary shaft portion 16. The fixed portion 12, the main shaft portion 14 and the secondary shaft portion 16 are coaxially arranged with each other. The fixing portion 12 is formed at a distal end of the shaft 10 opposite to the secondary shaft portion 16. The fixing portion 12 is a deformed three-sided prism configured for fixing with the body section 120 of the mobile phone 100 so that the shaft 10 is movable with the body section 120. The main shaft portion 14 is positioned between the fixed portion 12 and the secondary shaft portion 16. A diameter of the main shaft portion 14 is larger than that of the secondary shaft portion 16. A cam portion 1 8 is formed on a peripheral wall of the main shaft portion 14 adjacent to the fixing portion 12. The cam portion 18 includes a circular flange 182 and a pair of protrusions 184. Each protrusion 184 extends from one side of the flange 182 located opposite to the fixing portion 12. The protrusions 184 are thumb-shaped, and are spaced apart from each other at an angle of about 180 degrees. The secondary shaft portion 16 has a positioning portion 162 formed at a free end thereof. The positioning portion 162 is a substantially circular flange and has a larger diameter than the diameter of the secondary shaft portion 16, thereby forming a resisting section 164 at an interconnection between the secondary shaft portion 16 and the positioning portion 162.

The cam 20 is substantially cylindrical in form, and has a cam surface 22 formed at one end thereof. The cam surface 22 has a pair of valleys 222 and a pair of peaks 224. The cam 20 defines a through hole 24 along a radial direction in a central area thereof. A knob 26 is formed on an outer periphery of the cam 20 extending from one end to the other end. The knob 26 is configured for being fixed to the cover 110 so that the cam 20 is movable with the cover 110.

The first spring 30 is a coiled spring . A diameter of the spring 30 is larger than that of the main portion 14 of the shaft 10 so that the spring 30 may be placed around the shaft 10.

The locking member 40 has a substantially C-shaped configuration. The locking member 40 is stuck at the resisting section 164 of the positioning portion 162, and locks in one side of the positioning portion 162 of the shaft 10 so as to thereby prevent the first spring 30 and the cam 20 from becoming separated from the shaft 10 during operation.

The driving structure 220 includes a driving shaft 50, a gear 60, a sliding unit 70 and a cap 80.

The driving shaft 50 includes a deformable shaft portion 52 and a transmitting portion 54 connected to each other. The deformable shaft portion 52 has a slot 522 defined at a middle thereof along an axial direction. The slot 522 extends from a free end of the deformable shaft portion 52 to an intersection between the deformable shaft portion 52 and the transmitting portion 54, and separates the deformable shaft portion 52 into two equally sized parts. The slot 522 may be used for receiving flex wires of mobile phone 100. The deformable shaft portion 52 at a middle thereof forms a limiting ring 524 extending along a peripheral wall thereof. The limiting ring 524 is configured for fixing with the cover 110 so that the driving shaft 50 may rotate with the cover 110. The transmitting portion 54 is substantially cylindrical. A diameter of the transmitting portion 54 is larger than that of the deformable shaft portion 52. The transmitting portion 54 has a single tooth 542, which is a parabola surface. Opposite to the deformable shaft portion 52, a cylindrical end portion 56 extends from the transmitting portion 54.

The gear 60 has essentially smooth, even, continuous bare portion 64 (i.e., free of teeth and/or projections) extending between a first tooth/projection and a second tooth/projection. The bare portion 64 can occupy a radial percentage in the range from 10% to 50%, and preferably occupies a radial percentage in the range from 20% to 30%, of the cog 60. The teeth portions 62 are equally spaced along a peripheral wall of the gear 60. Each tooth portion 62 has a parabola-shaped outline, which is configured (i.e., structured and arranged) for engaging with the single tooth 542 of the driving shaft 50. The bare portion 64 is between a first tooth portion 62 and a last tooth portion 62, and has a smooth surface. The bare portion 64 may allow the driven shaft 50 to be driven when the gear 60 rotates clockwise, but the driven shaft 50 cannot be driven when the gear 60 rotates counter clockwise. A mounted portion 66 is formed at a side of the gear 60, and extends from the side of the gear 60.

The sliding unit 70 includes a rack 72, a button 74 and a second spring 76. The rack 72 has a plurality of latching teeth 722 formed extending upwardly between one end to and a middle thereof. The rack 72 forms a fixed piece 724 at the other end thereof. The button 74 has a bottom board 742 and an operating portion 744 formed integrally. The bottom board 742 is substantially rectangular, and is adhered to one side of the rack 72. The operating portion 744 has a grip portion (unlabelled) to facilitate operation by a user. The second spring 76 is a compression spring, and one end of the second spring 76 is attached to the fixed piece 724.

The cap 80 is substantially gourd-shaped, and defines a first hole 82 and a second hole 84. An axis of the first hole 82 is parallel to that of the second hole 84 and separated by a distance. The first hole 82 is used for receiving the end portion 56 of the transmitting portion 54, and the second hole 84 is used for receiving the mounted portion 66 of the gear 60.

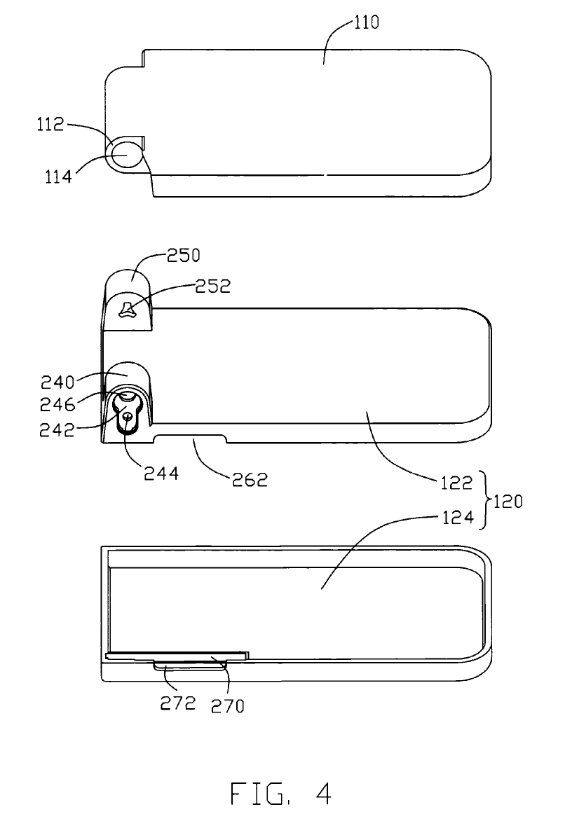

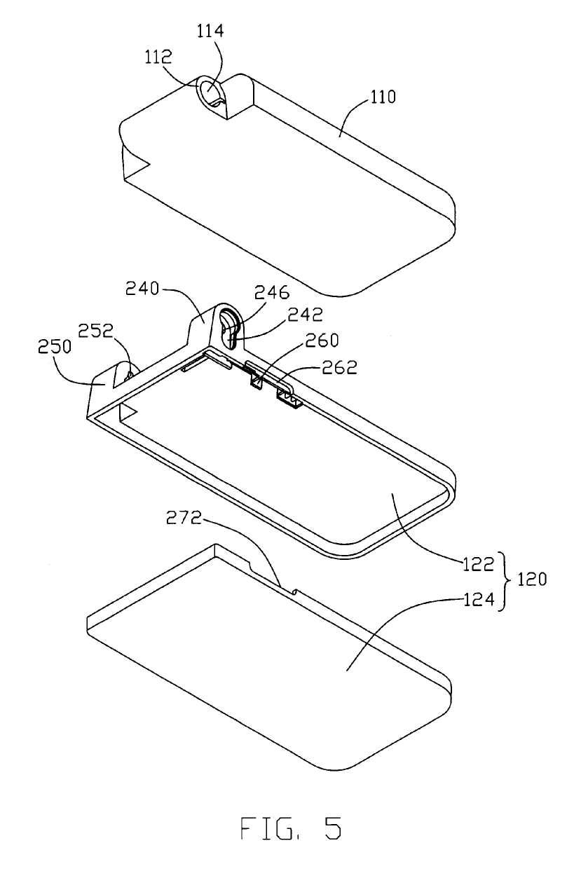

Referring to FIGS. 4 and 5, the cover section 110 has a hollow barrel 112 formed at one end thereof. The hollow barrel 112 has a receiving hole 114 defined by a peripheral wall. The peripheral wall defines a latching structure (not shown) for engaging with the limiting ring 524 of the driving shaft 50 and the knob 26 of the cam 20 so that the cover section 110 may rotate with the driving shaft 50 and the cam 20.

The body section 120 includes a first housing 122 and a second housing 124. The first housing 122 has a first mounted cylinder 240 and an opposite second mounted cylinder 250. An outer side of the first mounted cylinder 240 defines a latching cap hole 242, and the other side of the first mounted cylinder 240 defines a latching gear hole 244 and a latching driving shaft hole 246. The shape and the size of the latching cap hole 242 correspond to those of the cap 80 so that the cap 80 may cover the latching cap hole 242. The latching gear hole 244 is used for receiving the mounted portion 66 so as to allow the mounted portion 66 of the gear 60 to rotate in the latching gear hole 244. The latching driving shaft hole 246 is used for receiving the end portion 56 of the driving shaft 50 so as to allow the end portion 56 of the driving shaft 50 to rotate in the latching driving shaft hole 246. , The first housing 122 has an extending piece 260 formed at one side thereof adjacent to the first mounted cylinder 240. An opposite end of the second spring 76 may resist the extending piece 260. The first housing 122 defines a cutout 262 at one side surface thereof. The cutout 262 is positioned opposite to the extending piece 260. The second mounted cylinder 250 defines a deformable hole 252 for receiving the fixed portion 12 of the shaft 10.

The second housing 124 defines a cavity 270 and an opening 272 at one side thereof opposite to the first housing 122. The cavity 270 communicates with the opening 272. The cavity 270 is used for receiving the rack 70, the bottom board 742 of the button 74 and the second spring 76. The opening 272 communicates with the cavity 270. The first housing 122 and the second housing 124 may be snappingly engaged, with the opening 272 opposite to the cutout 262 so as to receive the operating portion 744 of the button 74.

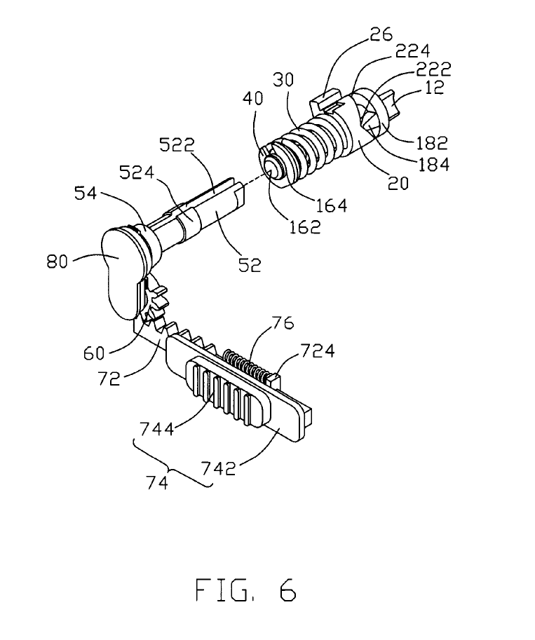

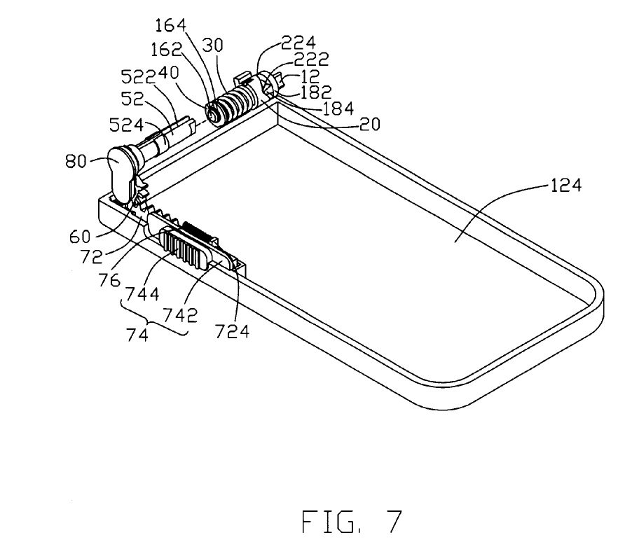

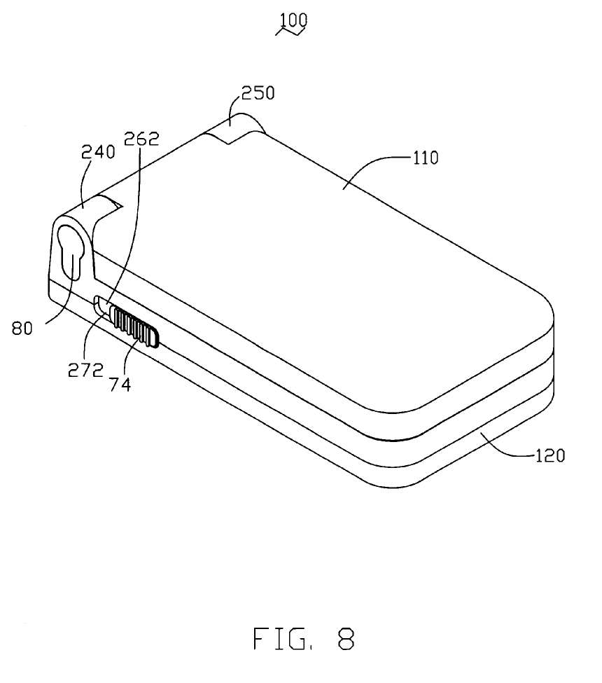

In assembly, referring to FIGS. 6 to 8, the main shaft portion 14 of the shaft 10 is inserted through the cam 20, the first spring 30 and the locking member 40. The locking member 40 is locked to the resisting section 164 of the positioning portion 162 of the shaft 10. Therefore, the hinge assembly structure 210 is integrated into a modular unit. Then, the hinge assembly structure 210 is inserted into the barrel 112 of the cover section 110. At the same time, the protrusion 184 engages in the latching structure of the cover section 110 of the mobile phone 100, and the fixing portion 12 of the shaft 10 engages in the deformable hole 252 of the body section 120 of the first housing 122 of the mobile phone 100. Accordingly, the hinge assembly structure 210 is assembled in the mobile phone 100.

After the hinge structure 210 is assembled, the driving structure 220 is assembled. Firstly, the driving shaft 50 passes through the hollow barrel 112 of the cover section 110, and the limiting ring 524 engages with the latching structure of the cover section 110 so as to rotate with the cover section 10. The end portion 56 of the driving shaft 50 is inserted into the latching driving shaft hole 246. Thus, the driving shaft 50 is assembled in the first housing 122. Then, the gear 60 is aligned with the latching gear hole 244 of the first housing 122, and the mounted portion 66 of the gear 60 is inserted into the latching gear hole 244. The mounted portion 66 of the gear 60 rotatably engages in the latching gear hole 244. The tooth 542 of the transmitting portion 54 needs to be kept opposite to the bare portion 64 of the gear 60. Next, the sliding unit 70 is placed in the cavity 270 of the second housing 124. The rack 72 and the bottom board 742 are received in the cavity 270 of the second housing 124, and the operating portion 744 is shown from the opening 272. After that, the first housing 122 is snappingly engaged with the second housing 124. The second spring 76 resists the extended piece 260 of the first housing 122, and the latching teeth 722 of the rack 72 engage with the teeth portion 62 of the gear 60. Finally, the cap 80 covers the latching cap hole 242 of the first housing 122. Accordingly, the hinge assembly system 200 is thus completely assembled.

When the cover section 110 of the mobile phone 100 is in a fully closed position, the protrusions 184 of the shaft 10 are held in the valleys 222 of the cam 20, and the hinge structure 210 is in a steady state. The operating portion 744 is set at a far end relative to the opening 272 and the cutout 262. If the cover section 110 of the mobile phone 100 is opened, the operating portion 744 is pushed forwards by hand. Owing to the button 74 being fixed to the rack, the rack 72 slides forwards relative to the body section 120. At the same time, the second spring 76 is compressed. Thus, the gear 60 is caused to rotate clockwise owing to the engagement between the latching teeth 722 and the teeth portion 62 of the gear 60. The single tooth 542 of the transmitting portion 54 is brought to rotate counter-clockwise by the gear. Therefore, the driving shaft 50 rotates relative to the body section 120. The cover section 110 further rotates relative to the body section 120. At the same time, the cover section 110 brings the cam 20 to rotate relative to the shaft 10. The protrusions 184 move away from the valleys 222, and slide along the cam surface 22. The cam 20 not only rotates relative to the shaft 10, but also moves toward the locking element 40. Accordingly, the first spring 30 is further compressed. When the protrusions 184 pass over the peaks 224 of the cam surface 22, the button 74 is released. The second spring 76 is extended to return to an original state, and brings the rack 72 to move backwards. Owing to the gear 60 rotating counter clockwise, the transmitting portion 54 cannot be driven and stops rotating. Therefore, the driving shaft 50 stops driving the rotation of the cover section 110. However, the protrusions 184 of the shaft 10 on the cam 20 are in an unsteady state. Therefore, even if the driven shaft 50 cannot drive the cover section 120 to rotate, the first spring 30 may still push the cam 20 to rotate until the cam 20 reaches its next steady state. Accordingly, the cover section 110 is thus opened automatically to a fully open position under the decompression force of the first spring 30.

When the cover section 110 of the mobile phone 100 is closed, the cover section 110 causes the cam 20 to rotate relative to the body section 120. The transmitting portion 54 of the driving shaft 50 only rotates around itself and cannot bring the gear 60 to rotate. Therefore, the cam 20 rotates along the shaft 10. After the cam 20 rotates to the critical position, the cam 20 continues to rotate under the impulse of the first spring 30 until the cam 20 tightly abuts the shaft 10 at a stable state. Accordingly, the cover section 110 becomes closed relative to the body section 120.

As described above, the present invention provides a hinge assembly system 200 for use with any various portable devices, beyond the mobile phone illustrated, and/or with other devices needing a hinge assembly that automatically facilitates the achievement of fully open position.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A driving structure comprising:
a driving shaft having a protrusion formed thereon;
a gear having a toothed portion and a bare portion extending between a first tooth and a second tooth of the toothed portion, the protrusion of the driving shaft moveable between the first and second teeth; and
a sliding unit, the sliding unit comprising a rack movable along opposite first and second direction, and an elastic element biasing the rack toward the second direction, the rack having a plurality of latching teeth engaging with the teeth portions of the gear;
wherein when an exterior force is applied to the sliding unit to move the rack along the first direction, the rack drives the gear to rotate and the first tooth of the gear pushes the protrusion so as to drive the driving shaft to rotate and, wherein once the exterior force is removed, the elastic element urges the rack along the second direction so as to return the gear back to its original position with the first tooth disengages from the protrusion.

2. The driving structure as claimed in claim 1, wherein the sliding unit further comprises a button, the button is fixed with the rack.

3. The driving structure as claimed in claim 1, wherein the protrusion of the driving shaft is a parabola surface, and each teeth portion is a parabola surface structured and arranged for engaging with the protrusion of the driving shaft.

4. The driving structure as claimed in claim 1, wherein the driving shaft includes a deformable shaft and a transmitting portion, the transmitting portion is positioned at one end of the deformable shaft, and the protrusion is positioned at the transmitting portion.

5. The driving structure as claimed in claim 1, wherein the rack includes a fixed piece, one end of the elastic element is fixed on the fixed piece.

6. A hinge assembly system, comprising:
a hinge assembly structure;
a driving structure, the driving structure comprising:
a driving shaft;
a gear engaging with the driving shaft in a manner such that the gear may drive the driving shaft to rotate but the driving shaft cannot drive the gear to rotate; and
a sliding unit, the sliding unit comprising a rack configured for driving the gear to rotate;
wherein the driving structure provides a force for the hinge assembly structure to cause the hinge assembly to rotate.

7. The hinge assembly system as claimed in claim 6, wherein the gear has toothed portions and an bare portion, the driving shaft has a single tooth, and the tooth of the driving shaft resisting one of the teeth portions adjacent to the bare portion.

8. The hinge assembly system as claimed in claim 7, wherein the single tooth of the driving shaft is a parabola surface, and each tooth portion of the gear is structured and arranged for engaging with the single tooth of the driving shaft.

9. The hinge assembly system as claimed in claim 8, wherein the driving shaft includes a deformable shaft and a transmitting portion, the transmitting portion is positioned at one end of the deformable shaft, and the single tooth is positioned at the transmitting portion.

10. The hinge assembly system as claimed in claim 6, the sliding unit further comprises an elastic element, the rack includes a fixed piece, one end of the elastic element is fixed on the fixed piece, and the elastic element provides a force to cause the rack to return an original position.

11. A foldable electronic device having a body section and a cover section hinged together by a hinge assembly system, the hinge assembly system comprising:
a hinge assembly structure;
a driving structure, the driving structure comprising:
a driving shaft being configured for being fixed relative to the cover section;
a gear engaging with the driving shaft in a manner such that the gear may drive the driving shaft to rotate but the driving shaft cannot drive the gear to rotate; and
a sliding unit, the sliding unit received in the body section, the sliding unit driving the gear to rotate;
wherein the driving structure provides a force allowing the hinge assembly structure to cause the hinge assembly to rotate so as to allow the cover section of the foldable electronic device to open automatically.

12. The foldable electronic device as claimed in claim 11, wherein the driving structure further comprises a cap, the body section defines a latching cap hole, and the cap covers the latching cap hole.

13. The foldable electronic device as claimed in claim 11, wherein the gear has toothed portions and a bare portion, the driving shaft has a single tooth, and the tooth of the driving shaft resists one of the toothed portions adjacent to the bare portion.

14. The foldable electronic device as claimed in claim 13, wherein the driving shaft includes a deformable shaft and a transmitting portion, the transmitting portion is positioned at one end of the deformable shaft, and the single tooth is positioned at the transmitting portion.

15. The foldable electronic device as claimed in claim 11, wherein the sliding unit comprises a rack and an elastic element, the rack having a plurality of latching teeth engaging with the teeth portions of the gear, the rack includes a fixed piece, one end of the elastic element is fixed on the fixed piece, and the elastic element provides a force to cause the rack to return an original position.

16. The foldable electronic device as claimed in claim 15, wherein the body section defines an extending piece, and the other end of the elastic element resisting the extending piece of the body section.
